(19) United States
(12) Patent Application Publication
(10) Pub. No.: US 2011/0155851 A1
(43) Pub. Date: Jun. 30, 2011

(54) AIRCRAFT OBSERVATION WINDOW

(75) Inventors: Alejandro Morales Soto, Madrid (ES); Francisco Javier Arribas Leon, Madrid (ES)

(73) Assignee: EADS CONSTRUCCIONES AERONAUTICAS, S.A., Madrid (ES)

(21) Appl. No.: 12/979,157

(22) Filed: Dec. 27, 2010

(30) Foreign Application Priority Data
Dec. 28, 2009 (ES) ES200931276

(51) Int. Cl. B64C 1/14

(52) U.S. Cl. 244/129.3

(57) ABSTRACT

Aircraft observation window (1) comprising external means of observation (10) permitting, the window (1) being in closed position, observation of the exterior in flight, and locking means (30) permitting the securing and locking of the window (1), the latter being in closed position in flight, furthermore comprising opening means (40) permitting opening of the external means of observation (10) when the aircraft is in flight, and securing means (50) permitting housing in a safe manner and securing of external means of observation (10), the same having been opened in flight. The invention furthermore relates to a method for rendering such observation window (1) practicable.

### FIELD OF THE INVENTION

The present invention relates to a configuration for the disposition of a practicable observation window in an aircraft and a method for rendering an observation window practicable.

### BACKGROUND

The present systems of observation windows realized in the fuselage of an aircraft are based on a fixed disposition of said windows, the aforesaid windows being installed in an immobile form as a consequence of the difficulty surrounding the creation of an aperture in the fuselage and moreover ensuring that said window cannot be opened in flight in an unexpected manner. Furthermore the fact of realizing such observation windows entails an additional difficulty by virtue of the fact that the openings required to be realized in the fuselage are larger than those realized for traditional windows, rendering it necessary to employ particular structural reinforcements.

Thus an aircraft window structure is known from document US 2008/0217479 attached by flanges 18 whereto are joined clips 14 such that said structure may easily be installed and uninstalled by means of aforesaid clips 14. Nevertheless such structure is fixed and does not permit opening or closing thereof in flight. Similarly an attachment system for an aircraft window is known from document US 2007/053423 comprising flexible clips 38 attached to retaining fittings 28. Nevertheless such structure is also fixed and does not permit being opened in flight.

Document EP 1348621 discloses a system of attaching aircraft windows which may be installed and uninstalled in a simple manner by a releasable attachment mechanism comprising attaching mechanisms 25 and 35. A similar system thereto is disclosed in document EP 1306302. Said systems are designed for rapid and easy installation and removal of aircraft windows, although they do not permit opening or closing thereof in flight.

Other documents, such as for example EP 1991803, disclose systems directed towards the retention and attachment of an aircraft window, however they do not permit such structures to be opened whilst the aircraft is in flight either. Document U.S. Pat. No. 6,082,674 discloses a system for attachment of aircraft windows by means of fasteners 66 and rails 30, having projecting parts engaging with clips 26 to permit installation of windows in an aircraft in a simple and more rapid manner. As in the case of the foregoing systems, it does not permit opening in flight either.

Document U.S. Pat. No. 4,364,533, which shall be considered as being the closest prior art to the invention, discloses a system for rapid installation and/or removal of aircraft windows such that passenger seats do not require removal. The system can pivot for installation in the correct manner from the back side (from within the aircraft fuselage). It does not describe a system permitting the opening of such windows whilst in flight either.

Consequently, the objective of the present invention is to develop an aircraft observation window practicable in flight, that is to say which may be opened whilst the aircraft is in flight in such a manner as to permit:
taking aerial photographs from the window without a translucent screen (glass) in front;
taking photographs from the exterior of the aircraft, putting the camera outside, by means of which cones of vision are increased very considerably, and
the possibility of observing the exterior, particularly in patrol or rescue missions.

In this manner the present invention has as its objective the provision of a window fulfilling the aforedescribed functions.

### SUMMARY OF THE INVENTION

Thus the present invention, according to a first aspect, relates to the configuration of an aircraft observation window practicable in flight, such that it may be opened and may subsequently be closed again, all whilst the aircraft remains in flight.

The observation window of the invention must therefore fulfil the following requirements:
as a consequence of the dimensions of a practicable window exceeding the dimensions of a normal window, it is necessary to realize the required reinforcements in the structure of the fuselage wherein said window is housed, in a manner such that said structure may resist the static, dynamic and fatigue loads typical of the aircraft;
the window of the intention shall ensure that operations for opening and/or closure thereof under flight conditions do not present resistance or friction in the mechanisms composing them, such that said operations may be realized in a simple and safe manner;
once opening the window of the invention has been realized, fastening of the part of the window which has been lowered must be ensured such that said part remains secured in a safe manner without risk of the unexpected falling thereof during flight; and
the window of the invention must moreover ensure that when it operates whilst in a closed position under conditions both of pressurized flight and of unpressurized flight, closure of the same is perfect and leak-free.

In order to ensure the foregoing, the present invention develops an aircraft observation window comprising:
external observation means permitting, when the window is in a closed position, observation of the exterior in flight;
primary structure housing the window in the structure of the fuselage of the aircraft wherein are housed the external means of observation of the window such that said structure of the fuselage comprises reinforcements permitting the structure to resist static, dynamic and fatigue loads characteristic of the aircraft;
locking means permitting securing and locking the window of the invention onto the structure of the fuselage of the aircraft when the aforesaid window is in a closed position in flight;
opening means permitting rotation and displacement of the external means of observation of the window of the invention in flight, such means avoiding resistance and friction in the window whilst it is being opened, this operation being realized in a simple and safe manner;
securing means permitting housing in a safe manner and securing the external means of observation of the window once the latter has been opened in flight, such means avoiding possible unexpected falling during flight;
supporting means fulfilling a dual function: providing the observer disposed at the observation window with a secure hold, facilitating the operation of the work thereof when such supporting means are raised and not lowered, permitting in the case of said supporting means having been lowered, operating the window and opening it.

According to a second aspect, the invention relates to a method for rendering an aircraft observation window practicable, such method comprising the following stages:
a) disposition of opening means in the window permitting rotation and simultaneous displacement (raising) of the external means of observation thereof in a guided manner and
b) disposition of securing means in the window permitting displacement of the external means of observation until securing thereof in a locked position, maintaining the window in an open position.

Furthermore, the foregoing method comprises the following stages:
c) disposition of lowerable supporting means in the window such that said means permit opening of the window;
d) disposition of locking means in the structure of the fuselage of the aircraft attaching the primary structure of the window, locking the same in the structure of fuselage;
e) disposition of structural reinforcements in the structure of the fuselage of the aircraft such that said structure may support the loads to which it is subjected on housing a window that is practicable in flight, and
f) dimensioning the external means of observation of the window such that the observer may look out and have a greater angle of vision when the window is in the closed position.

Other characteristics and advantages of the present invention will emerge from the detailed description below in relation to the accompanying figures.

### DESCRIPTION OF THE FIGURES

FIG. 1 shows a drawing of a conventional aircraft comprising observation windows.

FIG. 2 shows a detail of the fixed disposition of a known observation window in the fuselage of an aircraft.

FIG. 3 shows a drawing of the external means of observation of the observation window of the invention.

FIG. 4 shows a drawing of the housing of the primary structure of the observation window of the invention in the structure of the fuselage of the aircraft, viewed from within the fuselage.

FIG. 5 shows a drawing of the primary structure of the observation window of the invention in the structure of the fuselage of the aircraft, viewed from outside the fuselage.

FIGS. 6a, 6b and 7 show details of the securing means of the observation window of the invention.

FIGS. 8a, 8b, 8c and 8d show in detail the locking means of the observation window of the invention.

FIGS. 9a and 9b show a detail of the operation of the locking means of the observation window of the invention, such means being open and being closed, respectively.

FIG. 10 shows in detail the means of opening the observation window of the invention.

FIG. 11 shows in detail the securing means of the observation window of the invention together with the mode of actuating the same.

FIG. 12 shows a drawing of the dispositions of the observation window of the invention, closed during flight of the aircraft and open, however still without having been completely secured in the safety housing.

FIG. 13 shows a drawing of the disposition of the observation window of the invention having been opened and secured in flight.

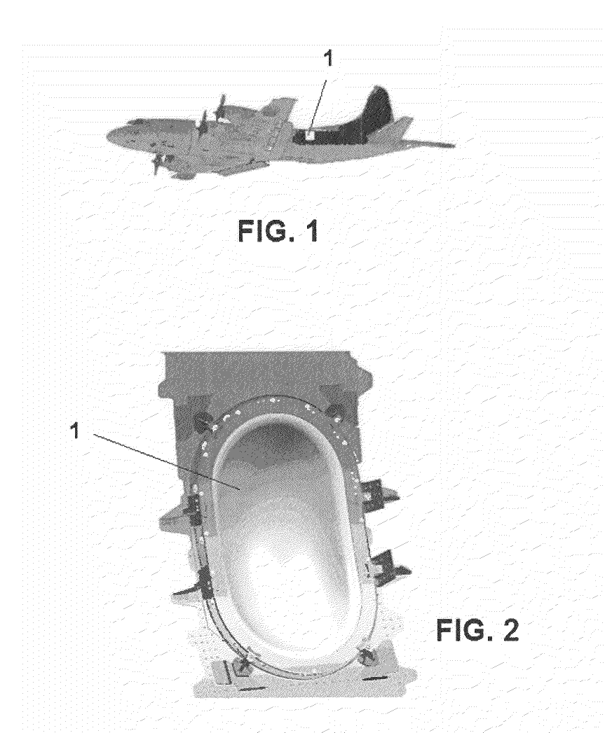

### DETAILED DESCRIPTION OF THE INVENTION

The invention relates to the configuration of an aircraft observation window 1 practicable in flight such that it may be opened and may be subsequently closed again, all whilst the aircraft remains in flight.

The aircraft observation window 1 of the invention comprises:
external means of observation 10 permitting, when window 1 is closed, observation of the exterior in flight;
primary structure 20, or frame of window 1, wherein external means 10 are housed, such primary structure 20 permitting the housing of the window 1 in the structure of the fuselage of the aircraft;
locking means 30 permitting securing and locking of window 1 when the latter is in the closed position in flight;
opening means 40 permitting rotation and displacement of external means of observation 10 in flight;
securing means 50 permitting housing in a safe manner and securing external means of observation 10 the same having been opened in flight, preventing possible unexpected falling during flight;
supporting means 60 providing, on the one hand, the observer disposed at the observation window with a secure hold when such supporting means 60 are raised and not lowered, furthermore permitting, on the other hand, when such means 60 are lowered, window 1 to be opened.

The structure of the fuselage of the aircraft wherein window 1 of the invention is located comprises structural reinforcements permitting the structure to resist static, dynamic and fatigue loads characteristic of the aircraft. Such structural reinforcements in the structure of the fuselage are of two types, which are necessary in order to create in said structure a larger opening (to house observation window 1 of the invention) than that initially planned. On the one hand, as shown in FIG. 5, the fuselage comprises external reinforcement 21 having the form of supplementary cladding attached to the formers and stringers of the fuselage to extend the life of the structure, resisting fatigue, such reinforcement 21 comprising crenellation 23 to improve inspectability of the structure, crenellations 23 coinciding with stringers and formers of the structure of the fuselage. Furthermore, as shown in FIG. 4, there being zones of cladding of the structure of the fuselage having differing thicknesses resulting from there having been realized an opening larger than that with which the structure was initially designed, it is necessary that supplements 22 be added such as to achieve uniform thickness of cladding such that the primary structure 20 of window 1 has uniform and homogenous support on the structure of the fuselage wherein it is disposed, achieving hermeticity in the joint, making pressurized flight of the aircraft possible.

In the interior of the aircraft comprising observation windows 1 according to the invention there will be located observation seats opposite each observation window 1 such that the following operations may be realized: observation and taking photographs. Such seats shall preferentially have differing adjustments for adaptation to the anthropometric measurements of the observer, and for adaptation in each case such that the operation may be realized in the most appropriate manner.

Observers disposed in the foregoing seats shall furthermore dispose of supporting means 60, such means preferentially comprising bars disposed at the interior part of windows 1 such that when said bars have not been lowered they remain facing the observer once seated. Such supporting means 60 are used as support by the observer, particularly at moments wherein the aircraft executes a turn for the purpose of the observer gaining angle of vision, supporting means 60 facilitating the operations thereof.

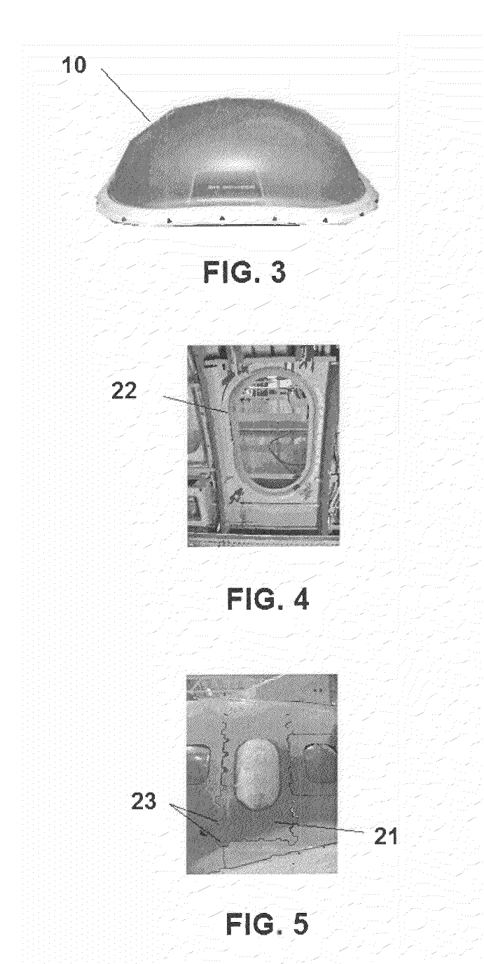

Exterior means of observation 10 of window 1 comprise preferentially a transparent carcass having a bubble form, as shown in FIG. 3, dimensioned such that the observer may look out having a greater angle of vision, window 1 being in the closed position.

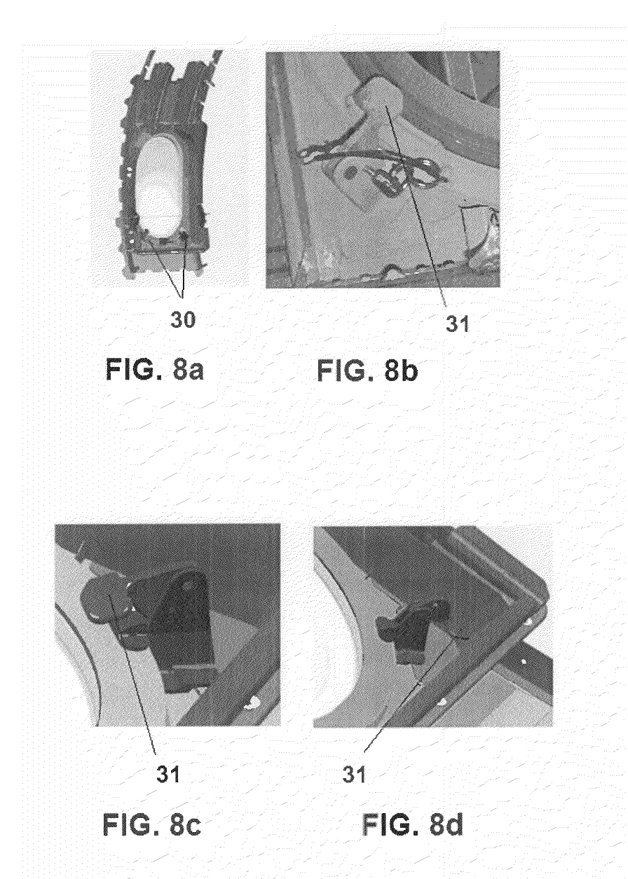

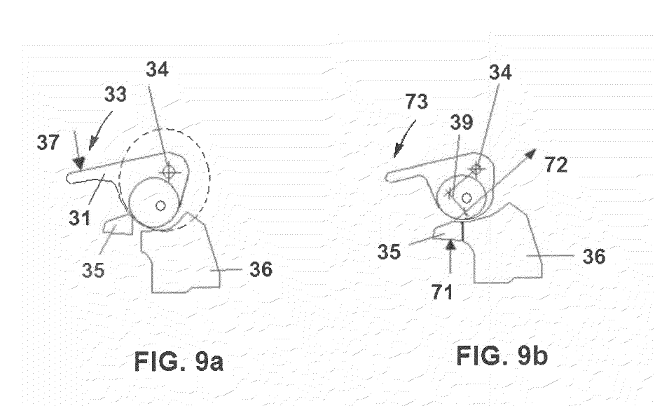

In the in-flight closed position of window 1 of the invention, as shown in FIG. 8a, primary structure 20 of said window 1 is secured to the fuselage of the aircraft by locking means 30, such means 30 comprising supports 31 which are intended to lock window 1 such that it cannot be opened in an accidental manner. Preferentially such supports 31 will be eccentric operators (FIGS. 9a and 9b).

As shown in FIG. 9a, an operator applies on eccentric operators 31 a force 37 to close window 1 such that parts 35 of the window and 36 of the fuselage come together closing the window as a result of the supporting force of eccentric operator 31 on section 35 of the window. Parts 35 of the window and 36 of the fuselage being in contact and window 1 having been closed, there consequently being no distance between them, as shown in FIG. 9b, should there appear for example force 71 on the window which would push against eccentric operator 31 making window 1 open, reaction force 72 is produced from section 35 of the window on eccentric operator 31, the line of action whereof being below the axis of rotation 34 of eccentric operator 31 at a distance 39 therefrom. Such disposition causes moment 73 to appear on aforesaid operator 31, said moment 73 making operator 31 maintain parts 35 and 36 in contact and, therefore, keeping the window closed, as shown in FIG. 9b.

Consequently when the aircraft is in unpressurized flight the design of said eccentric operators 31 will tend to make window 1 remain permanently closed as a consequence of the eccentricity produced between the point of application of reaction 72 and axis of rotation 34, and moment 73 which is generated. In pressurized flight of the aircraft the difference in pressures between the exterior and the interior of the aircraft will maintain and ensure, in addition to eccentric operators 31, that window 1 remains closed.

Moreover locking means 30 comprise fasteners on operators 31 ensuring that window 1 remains closed both in pressurized and in unpressurized flight, as observed in FIG. 8b.

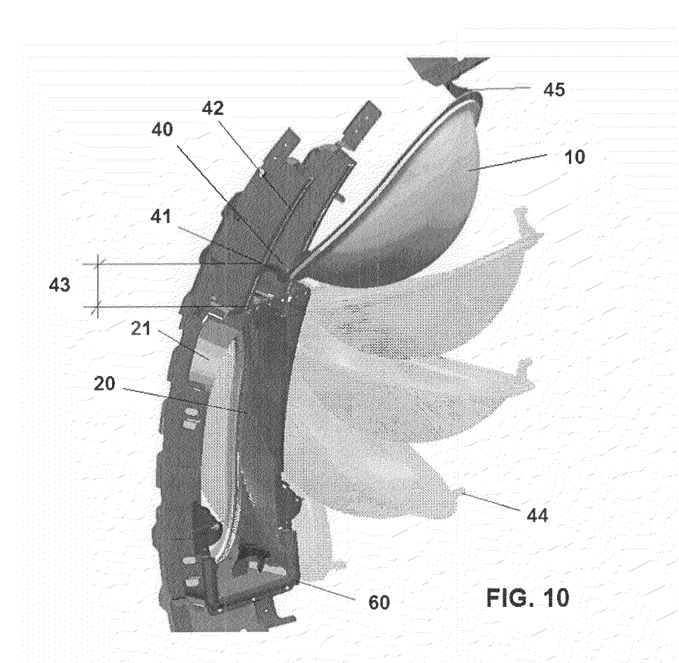

Window 1 of the invention comprises opening means 40, in turn comprising pivoting means 41 and first guiding means 42. Such opening means 40 are shown with greater clarity in FIG. 10. In said Figure it may be observed that external means of observation 10 of window 1 having been opened, following unlocking locking means 30, said external means 10 rotate around pivoting means 41 whilst being displaced at a distance 43 along first guiding means 42, such first guiding means 42 comprising preferentially guides or rails, as shown in FIG. 10. In this manner external means of observation rotate and are raised until the element 44, typically a roller, becomes housed in 45.

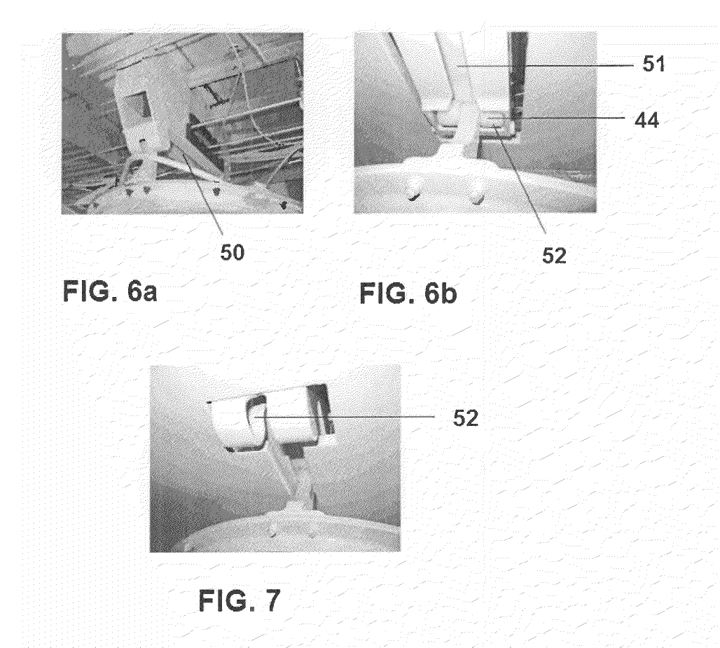

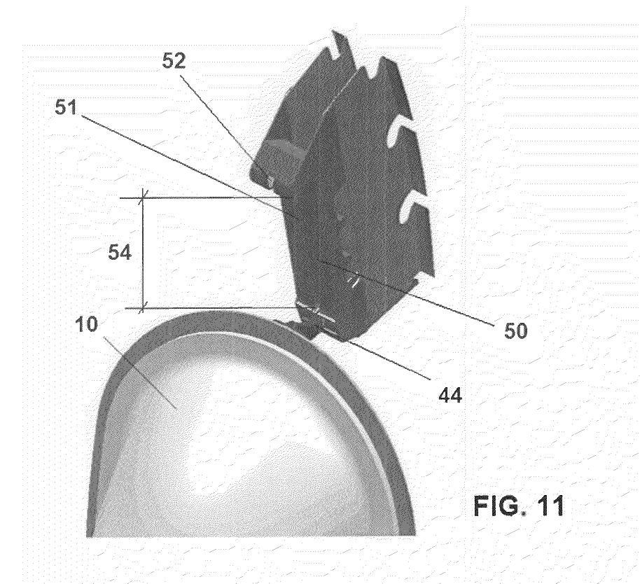

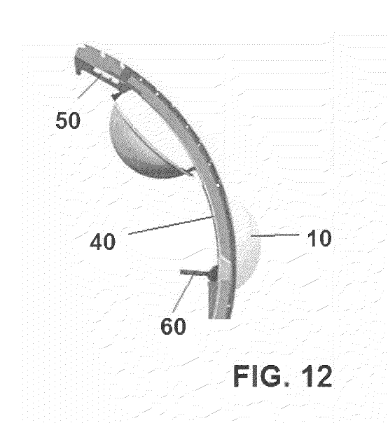

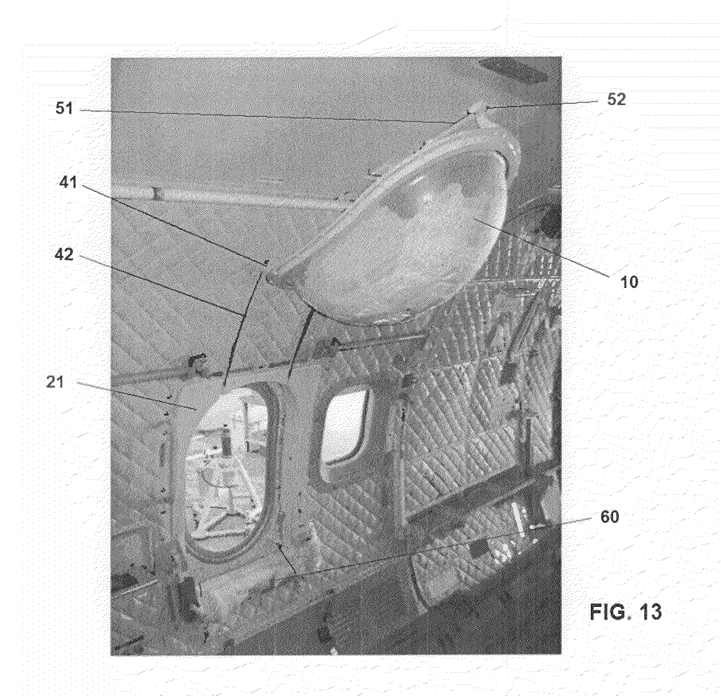

Practicable window 1 having been opened, that is to say external means of observation 10 thereof having been opened, such means 10 are secured by securing means 50 so as to prevent the same becoming detached. Securing means 50 in turn comprise a second guiding means 51 and a safety housing 52, as shown in drawing form in FIGS. 6a, 6b and 7. Consequently the operation of securing is realized by guiding means 10 and subsequent housing of said means in 52, such that means 10 become locked in the open position thereof in flight. As shown in FIG. 11, external means of observation 10 are displaced along a second guiding means 51 at a distance until the element 44 becomes housed in safety housing 52 in such manner that means 10 become firmly secured in the open position thereof without the possibility of falling.

According to a second aspect, the invention relates to a method for rendering practicable observation window 1 of an aircraft, such method comprising the following stages:
a) disposition of opening means 40 in window 1 permitting rotation and simultaneous displacement (raising) of external means of observation 10 of window 1 in a guided manner by first guiding means 42, and
b) disposition of securing means 50 in window 1 permitting displacement of external means of observation 10 of said window 1 until securing thereof in locked position in safety housing 52 by second guiding means 51, maintaining window 1 in an open position.

Furthermore said foregoing method comprises the following stages:
c) disposition of lowerable supporting means 60 in window 1 such that said means 60 permit the opening of window 1;
d) disposition of locking means 30 in the structure of the fuselage of the aircraft, securing primary structure 20 of window 1, locking it on the structure of the fuselage;
e) disposition of structural reinforcements in the structure of the fuselage of the aircraft such that said structure may support loads to which the same is subjected on housing window 1, practicable in flight, such reinforcements comprising external reinforcement 21 in the form of supplementary cladding attached to the formers and stringers of the fuselage, in turn comprising crenellation 23 and supplements 22 to achieve uniform thickness of cladding of the structure of the fuselage such that primary structure 20 of window 1 has uniform and homogenous support on the structure of the fuselage wherein it is disposed, achieving hermeticity of the joint, rendering possible pressurized flight of the aircraft.
f) dimensioning of external means of observation 10 of window 1 such that the observer may look out and have a greater of angle vision when window 1 is in a closed position.

Whereas the present invention has been wholly described in connection with preferred embodiments it is clear that modifications may be introduced within the scope of the following claims, the same not being considered as being limited by such foregoing embodiments.

1. Aircraft observation window (1) comprising external means of observation (10) permitting, the window (1) being in closed position, observation of the exterior in flight, and locking means (30) permitting the securing and locking of the window (1), the latter being in closed position in flight, characterized in that it furthermore comprises opening means (40) permitting opening of the exterior means of observation (10) when the aircraft is in flight, and securing means (50) permitting housing in a safe manner and securing the external means of observation (10), the same having been opened in flight.

2. Observation window (1) according to claim 1 characterized in that it comprises opening means (40), comprising pivoting means (41) and first guiding means (42), such that the opening of such exterior means of observation (10) in flight is realized in a safe manner.

3. Observation window (1) according to any of the foregoing claims characterized in that the securing means (50) comprise second guiding means (51) and safe housing (52).

4. Observation window (1) according to any of the foregoing claims characterized in that the locking means (30) comprise eccentric operators (31) which, when the window is in the closed position, the generate moment (33, 73) on, causing the eccentric operator (31) making window (1) to remain permanently closed, including in unpressurized flight.

5. Observation window (1) according to any of the foregoing claims characterized in that the exterior means of observation (10) comprise a transparent carcass in bubble form dimensioned such that the observer may look out having a greater angle of vision, window (1) being in closed position.

6. Observation window (1) according to any of the preceding claims characterized in that it furthermore comprises supporting means (60) providing the observer disposed in observation window (1) with a secure hold.

7. Observation window (1) according to claim 6 characterized in that the supporting means (60) are lowerable, permitting the opening of window (1).

8. Method for rendering practicable an observation window (1) of an aircraft according to any of claims 1 to 7, characterized in that it comprises the stages of:
a) disposition of opening means (40) in the window (1) permitting rotation and simultaneous displacement (raising) of external means of observation (10) of window (1) in a guided manner by first guiding means (42), and
b) disposition of securing means (50) in the window (1) permitting displacement of external means of observation (10) of said window (1) until securing thereof in locked position in safe housing (52) by means of a second guiding means (51), maintaining window (1) in an open position.

9. Method according to claim 8 furthermore comprising a stage of disposition of lowerable supporting means (60) in window (1) such that said means (60) permit, on being lowered, window (1) to be opened.

10. Method according to either of claims 8-9 furthermore comprising a stage of disposition of locking means (30) in the structure of the fuselage of the aircraft for attaching the primary structure (20) of the window (1), locking it in the structure of the fuselage.

11. Method according to any of claims 8-10 furthermore comprising a stage of disposition of structural reinforcements in the structure of the fuselage of the aircraft such that said structure may support the loads to which the housing window (1) is subjected, practicable in flight, said reinforcements comprising external reinforcement (21) having the form of supplementary cladding to extend the life of the structure through resisting fatigue, and supplements (22) such as to achieve uniform thickness of cladding of the structure of the fuselage in such manner that the primary structure (20) of the window (1) has uniform and homogenous support on the structure of the fuselage wherein it is disposed, achieving hermeticity in the joint, rendering pressurized flight of the aircraft possible.

12. Method according to claim 11 wherein external reinforcement (21) is attached to formers and stringers of the fuselage, said reinforcement (21) comprising crenellation (23) to improve inspectability of the structure, crenellations (23) coinciding with stringers and formers of the structure of the fuselage.

13. Method according to any of claims 8-12 furthermore comprising a stage of dimensioning the external means of observation (10) of the window (1) such that the observer may look out and have a greater angle of vision when the window (1) is in a closed position.
